(19) United States
(12) Patent Application Publication
(10) Pub. No.: US 2008/0184642 A1
(43) Pub. Date: Aug. 7, 2008

(54) Latex foam insulation and method of making and using same

(76) Inventors: Laura Sebastian, Chattanooga, TN (US); Joseph Sherman, Rydal, GA (US); Alan P. Sellers, Rocky Face, GA (US)

Correspondence Address: KING & SPALDING LLP, 1180 PEACHTREE STREET, ATLANTA, GA, 30309-3521, US

(21) Appl. No.: 11/702,948

(22) Filed: Feb. 5, 2007

(51) Int. Cl. C08J 9/28; E04C 1/00

(52) U.S. Cl. 52/309.4; 521/72

(57) ABSTRACT

The invention comprises a method of insulating a structure. The method comprises providing a quantity of a foam-forming composition between structural elements and permitting the foam-forming composition to expand to form a foam. The foam-forming composition comprises an aqueous emulsion or solution of a natural or synthetic film-forming polymer, a surfactant, hydrogen peroxide and an activating agent which causes the hydrogen peroxide to release oxygen gas sufficient to produce a foam. An insulated structure is also disclosed.

### FIELD OF THE INVENTION

The present invention generally relates to latex foam. More particularly, this invention relates to latex foam made with a novel foaming agent and a novel process, which provides the foam with unexpected properties and characteristics. The present invention also relates to the use of latex foam as an insulating material, particularly for insulating structures.

### BACKGROUND OF THE INVENTION

Latex foams are known for use in insulating structures. U.S. Pat. Nos. 6,284,077; 6,291,536 and 6,414,044 (the disclosures of which are all incorporated herein by reference) disclose methods and compositions for insulating structures, such as the walls of a building. These patents disclose using a latex formulation comprising an aqueous emulsion of a film-forming polymer, a liquid propellant and a surfactant. The propellant is disclosed as comprising a liquefied gas, such as C₁-C₆ alkanes and C₁-C₆ alkenes, including propane, n-butane, isobutene, hexane, n-pentane, 2-methylbutane, 1-pentene, butane, 2-methyl-2-butene, cyclobutane, cyclopentane, cyclohexane, and halogenated hydrocarbons, including vinyl chloride, methyl chloride, methylbromide, dichlorodifluoromethane; 1,1,1,2-tetrafluoroethane and 1,1-difluoroethane. However, such processes are currently disfavored because of the release of hazardous volatile organic compounds (“VOCs”) into the environment.

It would, therefore, be desirable to provide a latex foam for insulating structures or other objects that does not produce hazardous VOCs.

### SUMMARY OF THE INVENTION

The present invention satisfies the foregoing needs by providing a method of forming insulation between structural elements. The method comprises providing a quantity of a foam-forming composition between structural elements and permitting the foam-forming composition to expand to form a foam. The foam-forming composition comprises a mixture of an aqueous emulsion or solution of a natural or synthetic film-forming polymer, a surfactant, hydrogen peroxide and an activating agent which causes the hydrogen peroxide to decompose thereby releasing oxygen gas which produces a foam.

In an alternate embodiment, the present invention comprises an insulated structure. The insulated structure comprises a first structural component and a second structural component and a foam at least partially disposed between the first and second structural components. The foam is formed in situ from a composition comprising a latex emulsion or solution of a natural or synthetic film-forming polymer, a surfactant, hydrogen peroxide and an activating agent which causes the hydrogen peroxide to decompose thereby releasing oxygen gas which produces a foam.

In another alternate embodiment, the present invention comprises a method of forming insulation between structural elements. The method comprises forming a foam by mechanically frothing a composition comprising an aqueous emulsion or solution of a natural or synthetic film-forming polymer and a surfactant. The mechanically frothed foam is then disposed between structural elements.

Accordingly, it is an object of the present invention to provide an improved latex foam.

Another object of the present invention is to provide a foam having improved properties for insulating structures.

Still another object of the present invention is to provide an improved method of insulating structures with foam.

A further object of the present invention is to provide a latex foam that does not involve the production of hazardous VOCs.

Yet another object of the present invention is to provide a latex foam for insulation purposes that has improved antimicrobial properties.

Another object of the present invention is to provide a latex foam for insulation purposes that has improved insecticidal properties.

These and other objects, features and advantages of the present invention will become apparent upon reviewing the following detailed description of the disclosed embodiments and the appended drawing and claims.

### BRIEF DESCRIPTION OF THE DRAWINGS

FIG. 1 is a schematic view of a disclosed embodiment of a plural-component proportional spraying system in accordance with the present invention.

FIG. 2 is a front view showing use of the spraying system in FIG. 1 to apply foam between the wall studs of a typical residential wall construction.

### DETAILED DESCRIPTION OF THE DISCLOSED EMBODIMENTS

The term latex is known by those skilled in the art to mean an aqueous emulsion of natural or synthetic rubber or plastic (synthetic polymer) globules. That is, water forms the continuous phase of the emulsion and natural or synthetic film-forming polymers form the discontinuous phase.

The term decomposition as applied to hydrogen peroxide, and as used herein, means that the hydrogen peroxide undergoes the chemical reaction shown below:

2H₂O₂ (aq)→2H₂O (l)+O₂ (g)

The term “activating agent” as used herein means any substance that causes hydrogen peroxide to undergo the chemical reaction shown above and described as decomposition.

The present invention provides an improved foam for insulating structures. This foam produces no hazardous VOCs in its formation process and releases no hazardous VOCs as the foam ages. The foam of the present invention can be made in two distinct ways. First, the foam can be made using a chemical foaming agent. Second, the foam can be made by mechanical frothing. Both of these methods of making a foam will be discussed further below.

### Chemical Foaming Agent

A formulation that can be used to make a disclosed embodiment of the foam of the present invention comprises a mixture of an aqueous emulsion of a natural or synthetic film-forming polymer, a surfactant, hydrogen peroxide and an activating agent for the decomposition of the hydrogen peroxide. The formulation includes a sufficient amount of hydrogen peroxide such that when the hydrogen peroxide decomposes it releases enough oxygen gas to convert the formulation to a foam. The formulation also includes a sufficient amount of an activating agent such that it causes the hydrogen peroxide to decompose at a desired rate and produces a desired amount of oxygen gas to convert the formulation to a foam.

A typical formulation in accordance with the present invention is shown in Table 1 below.

TABLE 1

| Polymer | Parts by Weight | Percent by weight |
|---|---|---|
| Natural Rubber latex* | 0–100 | 0–50 |
| Synthetic Rubber latex* | 0–100 | 0–50 |
| Surfactant | 1–50 | 0.5–20 |
| Activating agent | 0.1–4 | 0.05–5 |
| Hydrogen Peroxide | 1–20 | 1–10 |

*The amount of natural rubber latex and synthetic rubber latex cannot both be zero.

Aqueous emulsions or solutions of film-forming natural or synthetic polymers (both homopolymers and copolymers) useful in the present invention include, but are not limited to, styrene-butadiene latex, carboxylated styrene-butadiene latex, ethylene vinyl acetate latex, polyvinyl acetate latex, polyvinyl chloride latex, chloroprene latex, neoprene latex, silicone rubber dispersion, natural rubber latex, polyvinyl alcohol solution, polyvinyl alcohol solution stabilized with bromine, acrylic latex, styrene acrylic latex, vinyl acrylic latex, and compatible mixtures thereof. The amount of the aqueous emulsion of film-forming natural or synthetic polymers used in the formulation of the present invention depends on the type of application for which the foam will be used. Preferably, the amount of an aqueous emulsion of film-forming natural or synthetic polymers useful in the present invention is about 15% to about 99% by weight of the formulation; especially, about 15% to about 50% by weight of the formulation.

Prior art latex formulations typically have been a blend of natural and synthetic rubber latex, such as 60% to 90% by weight natural rubber latex and 10% to 40% by weight synthetic rubber latex. It is specifically contemplated as a feature of the present invention that the formulation of the present invention can be made from 100% synthetic rubber latex, such as 100% styrene-butadiene latex.

The amount of hydrogen peroxide used in the formulation of the present invention depends on the type of application for which the foam will be used. The amount of hydrogen peroxide used is an amount sufficient to produce sufficient oxygen gas to produce a foam of a desired density. Preferably, the amount of hydrogen peroxide useful in the present invention is about 0.5% to about 40% by weight of the formulation; especially about 1% to about 10% by weight of the formulation.

Activating agents useful in the present invention are any material that catalyzes the decomposition of hydrogen peroxide. Activating agents useful in the present invention include, but are not limited to, enzymes, proteins and oxidizing/reducing agents that catalyze the decomposition of hydrogen peroxide. The amount of activating agent used in the formulation of the present invention depends on the type of application for which the foam will be used. The amount of activating agent used is an amount sufficient to catalyze the decomposition of the hydrogen peroxide in the desired amount of time to produce a foam of a desired density. Preferably, the amount of activating agent useful in the present invention is about 0.05% to about 5% by weight of the formulation; especially, about 0.1% to about 1% by weight of the formulation.

Any protein that catalyzes the decomposition of hydrogen peroxide can be used in the formulation. The enzymes listed below are all proteins. Other proteins useful in the present invention include, but are not limited to, casein. Yeasts, such as Saccharomyces cerevisiae (better known as Baker's yeast), can be used as an activating agent in the present invention.

Any enzyme that catalyzes the decomposition of hydrogen peroxide can be used. Enzymes useful in the present invention include, but are not limited to, catalase, chymotrypsin, lipase, rennet, trypsin, actinidin, α-amylase, β-amylase, bromelain, β-glucanase, ficin, lipoxygenase, papain, asparaginase, glucose isomerase, penicillin amidase, protease, pullulanase, aminoacylase, glucoamylase, cellulase, dextranase, glucose oxidase, lactase, pectinase, pectin lyase, protease, raffinase, invertase, and mixtures thereof.

Any oxidizing/reducing agent that catalyzes the decomposition of hydrogen peroxide can be used. Oxidizing/reducing agents useful in the present invention include, but are not limited to, CuCl₂, CuO, ZnO, MnO₂, KI, and Fe(II) and Fe(III) oxides. Iron oxide-bearing clays, such as montmorillonite K10, can also be used as activating agents in the present invention.

Surfactants that can be used in the present invention are any surfactant that is compatible with the aqueous emulsions or solutions of film-forming natural or synthetic polymers and other components of the formulation of the present invention and provide sufficient foam strength to maintain the foam structure until the foam is cured. Surfactants that can be used in the present invention include non-ionic and anionic surfactants. Non-ionic surfactants useful in the present invention include, but are not limited to, linear or nonyl-phenol alcohols, such as t-octylphenoxypolyethoxyethanol and/or fatty acids. Anionic surfactants useful in the present invention include, but are not limited to, ether sulphates, such as sodium lauryl sulfate or ammonium lauryl sulfate; ether phosphates, such as ethoxylated succinates; sulphosuccinates, such as disodium N-octadecyl sulfosuccinamate (Aerosol 18 available from Tiarco, Dalton, Ga.) and tetrasodium N-(1,2-dicarboxyethyl)-N-octadecyl sulfosuccinamate (Aerosol 22 available from Tiarco, Dalton, Ga.); ether carboxylates or ammonium, sodium or potassium salts of caprylic, laurate, oleate or stearic acids. Specific surfactants desired for use in the present invention include, but are not limited to, stearic acid, t-octylphenoxypolyethoxyethanol (Triton X-100), potassium behenate, sodium sulphosuccinate, and ammonium lauryl sulfate. Surfactants can be used in the formulation of the present invention in amounts sufficient to form a stable foam. Such surfactants can be added in amounts of about 0.5% to about 20% by weight of the formulation; preferably, about 5% to about 15% by weight of the formulation; especially, about 8% to about 12%.

The formulation of the present invention can also include various additives to improve or adjust the properties of the foam as desired. Such additives can include, but are not limited to, fillers, thickening agents, gelling agents, vulcanizing agents, accelerators, antimicrobial agents, insecticidal agents, fire retardants and other additives typically included in prior art latex foam formulations.

Gelling agent are frequently used in latex formulations to reduce the amount of time it takes for the foam to achieve a solid or partially solid state. Typical gelling agents used for latex formulations can be used in the formulation of the present invention. Such gelling agents include, but are not limited to, sulfur-containing compounds, chlorides, acetates; fluorides; and zinc salts know as gelling agents. The amount of gelling agent used in the formulation of the present invention is an amount sufficient to cause the formulation to gel within a desired time, such as within one hour. Such amounts include, but are not limited to, about 0.2% by weight to about 6% by weight of the formulation. Any compatible gelling agent can be used in the formulation of the present invention and many such gelling agent are well know to those skilled in the art, such as ammonium or amine salts, for example ammonium acetate. However, a time-based gelling agent, such as sodium silicofluoride, is preferred. A particularly preferred formulation includes about 10 weight parts of an aqueous emulsion of a film forming polymer, about 4 weight parts hydrogen peroxide, about 1 weight part gelling agent and about 0.1 weight parts activating agent.

Typical ingredients used as fillers in the composition of the present invention include, but are not limited to, aluminum trioxide, such as P-130A available from Custom Grinders Sales, Inc., Chatsworth, Ga.; aluminum silicate, such as LU-400 available from Lawson-United Feldspar & Mineral Co./ K-T Feldspar, Spruce Pine, N.C.; calcium carbonate, such as 200-W available from Georgia Marble Company, Dalton, Ga.; glass bubbles, such as K or S series glass bubbles commercially available from 3M Corp., St. Paul, Minn., Dualite, Cenospheres, Hollow spheres from Potter's Industries; hollow plastic spheres (i.e., acrylonitrile shells), magnesium hydroxide, such as MagneClear 58 available from Martin Marietta Magnesia Specialties, Inc., Baltimore, Md.; fiberglass available from JPS, South Carolina; Portland cement; barites; fly ash; ground glass (i.e., glass cullet), rubber crumb, and other inorganic materials. Glass bubbles are preferred because these low density microspheres increase buoyancy, decrease thermal conductivity and reduces shrinkage of the foam. Filler amounts used in the formulation of the present invention are preferably 0% to about 45% by weight of the formulation; especially, about 5% to about 25% by weight of the formulation. Flame retardant fillers or flame retardant additives, such as magnesium hydroxide, aluminum trihydrate or expandable graphite, can also be added to the formulation. Such flame retardant fillers or flame retardant additives can be added in amounts of 0% to about 45% by weight of the formulation.

Antimicrobial additives can be added to help control mold and mildew growth in wet environments. Such antimicrobial additives can be added in amounts of 0% to about 10% by weight of the formulation; preferably, about 0.5% to about 10% by weight of the formulation. Antimicrobial agents include fungicides, algaecides, mildewcides, and the like. Fungicides useful in the present invention include, but are not limited to, tin metals, Kordec 50C (i.e.; 5-chloro-2-methyl-isothiazolin-3-one) or 1,2-benzisothiazolin-3-one (available from Arecia). Algaecides useful in the present invention include, but are not limited to, tetrachloroisophthalonitrile or zinc pyrithione (Zinc Omadine available from Arch Chemical). Mildewcides useful in the present invention include, but are not limited to, octhilinone (i.e.; 2-octyl-1,2-thiazol-3(2H)-one) or 2-methyl-4-isothiazolin-3-one (Kathon 893 available from Rohm & Haas).

Also, scents or odor eliminators can be added to the formulation. Such scents or odor eliminators can be added in amounts of 0% to about 15% by weight of the formulation.

Depending on the desired physical properties of the finished foam or the nature of the structure being insulated, other materials can be incorporated into the formulation to achieve the desired effect, while maintaining the performance of the foam.

It is specifically contemplated as a feature of the present invention that the formulation of the present invention can have a solids content of greater than 60% by weight. The higher solids content of the formulation of the present invention permits the use of less water in the formulation which, in turn, permits more rapid drying of the formulation.

Table 2 below shows preferred ranges of the ingredients of a disclosed embodiment of the formulation of the present invention.

TABLE 2

| Polymer | Parts by Weight | Percent by weight |
|---|---|---|
| Natural rubber latex | 20–100 | 9.84–17.98 |
| Synthetic rubber latex | 80–100 | 39.38–17.98 |
| Filler | 100–400 | 49.22–53.95 |
| Thickening agent | 0.05–4 | 0.025–0.72 |
| Accelerator | 1–15 | 0.5–2.7 |
| Vulcanizer | 0.25–3 | 0.125–0.54 |
| Gelling agent | 0.25–5 | 0.12–0.9 |
| Surfactant | 1–50 | 0.5–20 |
| Other Additives | 0.5–5 | 0.25–0.9 |
| Activating agent | 0.1–4 | 0.05–0.72 |
| Hydrogen Peroxide | 1–20 | 0.5–3.6 |

It has been further discovered that the inclusion of starch, stearic acid or combinations thereof, improves the retention of gas bubbles within the formulation of the present invention, thereby making the foam more stable. Starches useful in the present invention include, but are not limited to, starch from fruits, seeds, rhizomes or tubers of plants. Preferred starches are corn starch, potato starch, rice starch and wheat starch. Salts of stearic acid include, but are not limited to, salts of alkali metals and salts of alkaline earth metals, such as potassium stearate, sodium stearate, zinc stearate and magnesium stearate. The amount of starch, stearic acid or salts of stearic acid optionally included in the formulation is an amount sufficient to improve the gas bubble retention within the foam; preferably about 0.20% to about 100% by weight of the formulation; especially, about 0.22% to about 90% by weight of the formulation.

Another feature of the present invention is the ability to very precisely control the amount of blowing of the foam. By controlling the amounts of the hydrogen peroxide and the activating agent in the formulation and the ratio of the activating agent to the hydrogen peroxide, the amount of blowing, and, therefore, the amount of foam generation, can be precisely determined, controlled and reproduced.

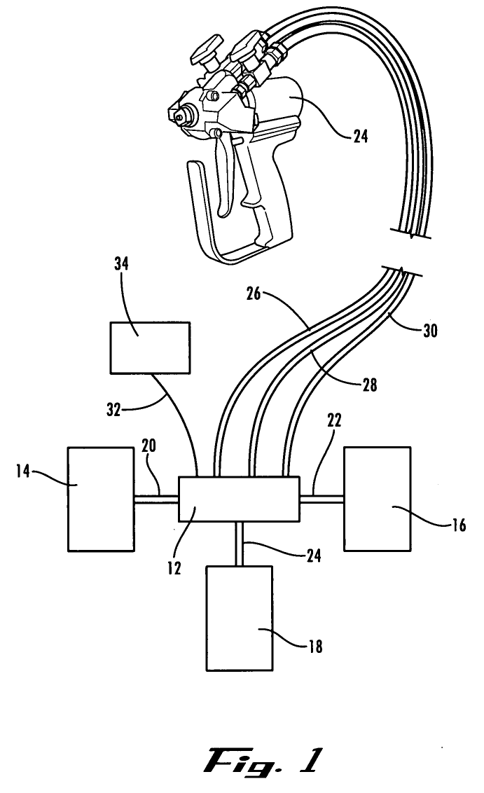

With reference to the drawing in which like numbers indicate like elements throughout the several views, it will be seen that there is disclosed a spray foam system 10 (FIG. 1), in accordance with the present invention. The spray foam system 10 comprises a plural-component proportional pump 12 capable of pumping multiple streams of components. Such pumps are well known in the art and are commercially available, such as the Reactor E-Series line of plural-component proportioning sprayers available from Graco, Inc., Minneapolis, Minn. Plural-component proportional pumps allow the delivery of two to four different components to a plural-component spray gun at desired component ratios. Plural-component spray guns are also available from Graco, Inc. and are also disclosed in U.S. Pat. No. 5,242,115 (the disclosure of which is incorporated herein by reference). Plural-component proportional pumps and plural-component spray guns are typically used to spray chemically blown polyurethane for insulating structures, such as residential homes and commercial buildings.

It is preferred that certain reactive components of the formulation of the present invention not be mixed together until just prior to spraying. Therefore, the plural-component proportional pump 12 is connected to three component reservoirs or tanks 14, 16 and 18. The tank 14 holds a blend of the latex portion and the activating agent portion of the formulation, the tank 16 holds the hydrogen peroxide portion of the formulation and the tank 18 holds the gelling agent portion of the formulation. The tank 14 is connected to the pump 12 by a pipe or hose 20. The tank 16 is connected to the pump 12 by a pipe or hose 22. The tank 18 is connected to the pump 12 by a pipe or hose 24.

The pump 12 is connected to a plural-component spray gun 24 by three flexible high pressure hoses 26, 28 and 30. The hose 26 delivers the blend of the latex portion and the activating agent portion of the formulation from the pump 12 to the spray gun 24. The hose 28 delivers the hydrogen peroxide portion of the formulation from the pump 12 to the spray gun 24. The hose 30 delivers the gelling agent portion of the formulation from the pump 12 to the spray gun 24. The pump 12 delivers these three components to the spray gun 24 under pressure so that they can be sprayed from the spray gun. The spray gun 24 also thoroughly mixes the three components together before they are sprayed from the gun spray nozzle.

The pump 12 is connected by an electric circuit 32 to a controller 34. The controller 34 provides precise control of the amounts and ratios of the three formulation components delivered to the spray gun 24. Thus, a user can adjust the pump 12 to provide any desired amount and/or ratio of amounts of the three formulation components to the spray gun 34, and, thereby, adjust the composition of the formulation actually being sprayed by the spray gun, as desired.

It is also contemplated that the pump 12 can provide four separate proportioned streams of material to the spray gun 24. In such case, a fourth reservoir or tank (not shown) would be connected to the pump 12 by a hose or pipe (not shown) and the pump 12 would be connected to the spray gun 24 by a fourth hose (not shown) which would deliver the fourth component from the fourth tank to the spray gun in the desired proportion or amount. If a four component system is used, the latex portion of the formulation and the activating agent portion of the formulation do not have to be pre-blended. The latex portion of the formulation can be stored in the tank 14 and the activating agent portion of the formulation can be stored in the fourth tank (not shown). The four components of the formulation; i.e., the latex portion, the activating agent portion, the hydrogen peroxide and the gelling agent portion, are delivered to the spray gun 24 in the desired ratios and amounts and the components are mixed in the spray gun immediately before being sprayed from the nozzle of the spray gun.

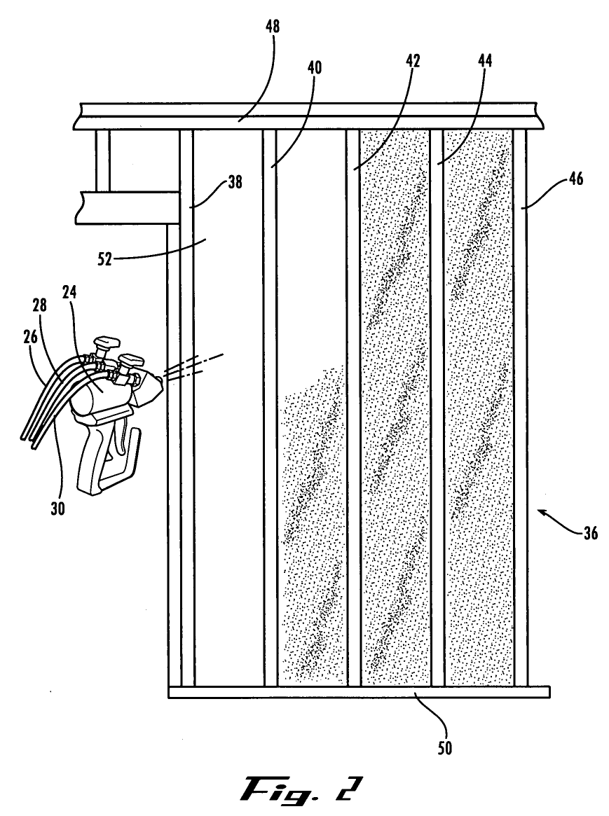

With reference to FIG. 2, it will be seen that there is a typical residential wall construction 36 comprising a series of adjacent vertical wall studs 38, 40, 42, 44 and 46, a top plate 48 and a bottom plate 50. The formulation of the present invention is sprayed from the spray gun 24 onto the anterior wall 52 between adjacent wall studs, such as wall studs 38 and 40. The formulation sprayed onto the wall 52 is initially a liquid which is sprayed onto the wall as a relatively thin coating. Then, as the activating agent in the formulation reacts with the hydrogen peroxide in the formulation, the hydrogen peroxide decomposes and produces oxygen gas in the formulation which causes the formulation to foam or blow in situ. Thus, the relatively thin coating is rapidly converted from a relatively thin liquid coating to a relatively thick foam coating that expands to fill the space between the adjacent studs 38 and 40. This foam insulation application technique is well known in the art and has been used for applying polyurethane insulation for many years. A similar technique is also disclosed in U.S. Pat. No. 6,414,044 (the disclosure of which is incorporated herein by reference).

A sufficient amount of the formulation of the present invention is sprayed onto the wall 52 such that when the foam expands, it completely fills the space between the adjacent studs and usually expends in excess of the depth of the wall. Therefore, after the foam has cured, at least to a self-supporting state, it is often necessary to trim off the excess foam that projects outwardly from the wall 52 beyond the studs 38 and 40, so as to provide a flat wall surface. This trimming step can be performed using a long sharp knife or a long saw (not shown) to trim the excess foam from the proximal wall surface. This foam trimming technique is also well known in the art and has been used for many years.

If it is desired to insulate an existing wall structure, a hole can be drilled in the hollow wall, a hose inserted into the hollow space and the formulation of the present invention can be pumped into the hollow space. Techniques for insulating existing hollow wall structures with an expandable foam, such as polyurethane, are well known in the art and can be used with the present invention. Similarly, techniques for insulating other structures with expandable foams, such as refrigerators, water heaters, and the like, are well known in the art and can be used with the present invention.

While the present invention has been described as useful for insulating a wall structure of a building, it is specifically contemplated that the present invention can be used to insulate the floor, ceiling or roof of a building. Thus, the foam of the present invention can be disposed between adjacent floor joists, adjacent ceiling joists or adjacent roof rafters.

### Mechanically Frothed Foam

Mechanically frothed foams in accordance with the present invention can also be used for insulating structures. The formulations for the mechanically frothed foams in accordance with the present invention are identical to the formulations for the chemically foamed or blown foams described above, except the formulations do not include both the hydrogen peroxide and the activating agent. Additionally, the level of surfactant may need to be higher, depending on the polymer used and the application for the foam. Generally speaking, the surfactant used to make the mechanically frothed foam is that amount necessary to produce a stable foam; preferably, about 1% to 30% by weight of the formulation; especially, approximately, 4% to 15% by weight of the formulation.

The mechanically frothed foam can be made by introducing the formulation of the present invention into a mechanical frothing machine. Mechanical frothing machines are well known in the art and are commercially available from E.T. Oakes Corp. Mechanical frothing machine produce foams by introducing a gas, such as air, into a liquid composition that includes a surfactant. Once the froth is generated in the mechanical frothing machine, it can be applied to a structure, such as the wall structure 36 (FIG. 2), in the manner disclosed in U.S. Pat. No. 6,414,044 (the disclosure of which is incorporated herein by reference). When forming the foam by mechanical frothing, the activating agent can be omitted from the formulation.

Both the chemically foamed or blown foam and the mechanically frothed foam of the present invention can be used to form insulated structures by pouring the formulation or frothed foam into the structure, into a mold or cast on a belt and cured. For example, both the chemically foamed or blown foam and the mechanically frothed foam of the present invention can be pre-formed, such as formed into foam slabs or foam panels. Such slabs or panels of foam can then be used to insulate structures, such as by placing the pre-formed foam between adjacent joists 38 and 40 (FIG. 2). Methods of forming foams in accordance with the present invention on a textile substrate are disclosed in co-pending application Ser. No. 11/510,256, filed Aug. 25, 2006 (the disclosure of which is incorporated herein by reference). When using pre-cast foams for insulating structures in accordance with the present invention, the foams can be cast on any suitable substrate for insulation including, but not limited to, a plastic film, fiberglass, cellulose or paper. Pre-cast foam can be installed in building structures, for example, by placing pre-cast strips of the foam material between adjacent wall studs and securing the foam in place by stapling the foam's substrate or backing to the wall studs, in a same manner well known in the art use for installing conventional fiberglass strip insulation. Also, strips of pre-cast foam can be laid between adjacent ceiling rafters. Alternately, uncured mechanically frothed foam can be placed between structural members, such as between adjacent wall studs, using a hose connected to a mechanical frothing machine and depositing the foam between the structural members. After drying and curing of the foam, excess foam extending beyond the structural members can be trimmed with a knife or saw in a manner well known in the art.

When using foams formed by mechanical frothing, the foams have the advantage of being substantially free from undesirable VOCs. It is specifically contemplated that the mechanically frothed formulations of the present invention do not include volatile organic solvents or volatile organic blowing agents.

The following examples are intended to illustrate the present invention, but are not intended to limit the scope of the present invention as set forth in the claims.

### EXAMPLE 1

A formulation suitable for use in the formulation of the present invention is prepared as described below. Table 3 shows the latex portion of the formulation.

TABLE 3

| Ingredient | Dry Weight | % Solids | Wet Weight |
|---|---|---|---|
| 3820 Latex | 100.00 | 67.00 | 149.25 |
| 1707 Soap | 3.60 | 20.00 | 18.00 |
| Lattice NTC 61 | 1.00 | 100.00 | 1.00 |
| B-20 Starch | 10.20 | 100.00 | 10.20 |
| ALS Soap | 1.19 | 28.00 | 4.25 |
| 20% K-Behenate | 1.07 | 20.00 | 5.35 |
| ATH 632 | 3.51 | 100.00 | 3.51 |
| Laponite RDS or | 1.80 | 100.00 | 1.80 |
| Garamite 1958 | | | |
| T-gum | 0.42 | 10.00 | 4.20 |

In Table 3 above, 3820 Latex is styrene-butadiene latex, commercially available from Polymer Latex, Pittsburgh, Pa.; 1707 Soap is potassium stearate, commercially available from Textile Rubber & Chemical Company, Inc., Dalton, Ga.; Lattice NTC 61 is cellulose, commercially available from FMC Polymer Division, Mechanicsburg, Pa.; B-20 Starch is corn starch, commercially available from Grain Processing Corp., Muskatine, Iowa; ALS Soap is ammonium laurel sulfate, commercially available from Textile Rubber & Chemical Company, Inc.; 20% K-Behenate is a behenic acid-based surfactant commercially available from Carter, N.J.; ATH 632 is aluminum hydrate commercially available from J.M. Huber Corp., Atlanta, Ga.; Laponite RDS is a synthetic layered silicate that acts as a rheology modifier, commercially available from Southern Clay Products, Inc., Gonzales Tex.; Garamite 1958 is a unique rheological additive available from Southern Clay Products, Gonzales, Tex. and T-gum is a polyacrylate commercially available from Textile Rubber & Chemical Company, Inc., Dalton, Ga.

The ingredients in Table 3 are blended together in a propeller-type mixer. The latex formulation (Table 3) is stored in tank 14 (FIG. 1). Hydrogen peroxide (50% by weight) and a gelling agent (e.g., sodium silica fluoride) in the ratio of 8.0 parts gel to 4.8 parts hydrogen peroxide are stored in tank 18.

Table 4 shows the activating agent portion of the formulation.

TABLE 4

| Ingredient | Dry Weight | % Solids | Wet Weight |
|---|---|---|---|
| Wingstay 29 emulsion | 1 | 50 | 3.7 |
| Kordek 50C | 4 | 100 | 0.1 |
| Kathon 893 | 3.1 | 100 | 1.0 |
| Nuocide 404D | 2.1 | 100 | 0.7 |
| Silica (Cab-o-sil EH-5) | 2 | 100 | 0.6 |
| Catalase (Americos XL) | 1 | 50 | 2.0 |

In Table 4 above, Wingstay 29 emulsion is a polymeric phenolic antioxidant, commercially available from Tiarco Chemical; Kordek 50C, 0.04% is a bactericide/mildewcide, commercially available from Rohm & Haas, Philadelphia, Pa.; Kathon 893, 0.31% is a 2-n-octyl-3-isothiazolone biocide/fungicide, commercially available from Rohm & Haas: Nuocide 404D, 0.21% is an isophthalonitrile fungicide, commercially available from ISP Chemical Company, Calvert City, Ky.; Silica (Cab-o-sil EH-5) is fumed silica, commercially available from Cabot Corp., Boston, Mass.; and Catalase (Americos XL) is a liver-based (animal) enzyme, commercially available from Genencor International, Mocksville, N.C.

The ingredients in Tables 3 and 4 are blended together in a propeller-type mixer, such that 322 wet weight part of the ingredients in Table 3 and 8.1 wet weight parts of the ingredients in Table 4 are combined. The blend of the latex portion (Table 3) and the activating agent portion of the formulation (Table 4) is stored in tank 14 (FIG. 1). The gelling agent portion of the formulation (an aqueous dispersion of 30% by weight sodium silicofluoride) is stored in the tank 18 and 50% by weight hydrogen peroxide is stored in tank 16.

The latex/activating agent portion of the formulation stored in tank 14, the hydrogen peroxide stored in tank 16 and the gelling agent portion of the formulation stored in tank 18 are fed to the pump 12 (FIG. 1). The ratio of the latex/activating agent portion of the formulation (Tables 3 and 4), the hydrogen peroxide and the gelling agent portion of the formulation are such that 330.1 wet weight parts by weight of the latex/activating agent portion of the formulation (Tables 3 and 4); 11.9 wet parts by weight gel and 7.2 wet parts by weight 50% hydrogen peroxide are pumped from the pump 12 to the spray gun 24. After mixing in the spray gun 24, the formulation is applied to the wall 52 (FIG. 2) in the manner described above. The coating of the formulation on the wall 52 expends to form a foam that fills the space between the adjacent wall joists 38-40. Any excess foam extending outwardly beyond the joists 38 and 40 is trimmed in the manner described above. The foam produced by this formulation is also substantially free from undesirable VOCs.

### EXAMPLE 2

The same procedure is followed as in Example 1 above, except the activating agents shown in Table 5 below are used as the activating agent in the activating agent portion of the formulation (Table 4) instead of the catalase enzyme.

TABLE 5

| Trial | Activating Agent |
|---|---|
| 1 | Lipase |
| 2 | α-amylase |
| 3 | Glucanase |
| 4 | Dextranase |
| 5 | Lactase |
| 6 | Pectinase |
| 7 | CuCl₂ |
| 8 | CuO |
| 9 | ZnO |
| 10 | MnO₂ |
| 11 | KI |
| 12 | Fe(III) oxide |
| 13 | Baker's yeast |
| 14 | Casein |

The resulting formulations are sprayed onto the wall structure 36 in the manner described above and forms a useful foam insulation.

### EXAMPLE 3

The same procedure is followed as in Example 1 above, except the synthetic rubber latexes shown in Table 6 below are used as the film forming polymer in the latex formulation (Table 3) instead of the blend of styrene-butadiene and natural rubber.

TABLE 6

| Trial | Synthetic Rubber Latex |
|---|---|
| 15 | ethylene vinyl acetate |
| 16 | polyvinyl acetate |
| 17 | vinyl acetate |
| 18 | Chloroprene |
| 19 | Neoprene |
| 20 | polyvinyl alcohol |
| 21 | acrylic |
| 22 | styrene acrylic |
| 23 | vinyl acrylic |
| 24 | silicone rubber emulsion |

The resulting formulations are sprayed onto the wall structure 36 in the manner described above and forms a useful foam insulation.

### EXAMPLE 4

In this Example, a foam formulation is prepared for use with a mechanical frothing machine, instead of using the hydrogen peroxide and activating agent as an in situ blowing agent. Table 7 below shows the antioxidant/antimicrobial agent portion of the formulation.

TABLE 7

| Ingredient | Dry Weight | % Solids | Wet Weight |
|---|---|---|---|
| REq-3523 Tgum | 120.92 | 61.82 | 195.72 |
| Wingstay 29 emulsion | 1 | 67.00 | 1.49 |
| Kordek 50C | 0.08 | 100 | 0.08 |
| Kathon 893 | 0.61 | 100 | 0.61 |
| Nuocide 404D | 0.41 | 100 | 0.41 |
| 3M K-1 Glass bubbles | 3.56 | 100 | 3.56 |
| Nyagraph 251 | 10.00 | 100 | 10.00 |

In Table 7 above, REq-5323 Tgum indicates the portion of the formula shown in Table 3. Wingstay 29 emulsion is a polymeric phenolic antioxidant, commercially available from Tiarco Chemical, Dalton, Ga.; Kordek 50C is a bactericide/mildewcide, commercially available from Rohm & Haas, Philadelphia, Pa.; Kathon 893 is a 2-n-octyl-3-isothiazolone biocide/fungicide, commercially available from Rohm & Haas; Nuocide 404D is an isophthalonitrile fungicide commercially available from ISP Chemical Company, Calvert City, Ky.; 3M K-1 glass bubbles are very low density glass microspheres that reduces thermal conductivity and increases R-value, commercially available from 3M, St. Paul, Minn. and Nyagraph 251 is expandable graphite flame retardant additive, commercially available from Nyacol Nano Technologies, Inc., Ashland, Mass.

The ingredients in Table 7 are blended together in a propeller-type mixer. This compound and compressed air are fed in the appropriate ratio to two static mixers positioned in series from which the mixture is subsequently fed to a mechanical frothing machine (not shown), such as a Texacote Foam Machine (Perpetual Machine Company, Dalton, Ga.), to dynamically mix the air and latex formulation. The amount of air mixed with the compound is adjusted to give a wet foam density ranging from about 30 to about 50 cup weight (grams per liter).

A 30 percent dispersion of sodium silicofluoride (SSF) gel is injected into the formulation of Table 7 at the rate of 5% (based on the wet weight of the latex compound) into the latter part of the head of the frothing machine where it is mixed with the latex/air mixture. This level of SSF gel is set to allow the latex compound to gel (convert from liquid to wet solid) in about one hour. The low density frothed latex compound/air/SSF gel mixture is then fed to a cavity between adjacent wall studs until the cavity is full. The frothed foam is then allowed to cure and dry. After the foam has cured, at least to a self-supporting state, any excess foam that projects outwardly from the wall beyond the adjacent studs is trimmed flush therewith so as to provide a flat wall surface. This trimming step is performed using a long sharp knife or a long saw to trim the excess foam from the wall surface. The cured and dried foam provides excellent insulation to the wall structure.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A method comprising:
providing a quantity of a foam-forming composition between structural elements; and
permitting said foam-forming composition to expand to form a foam, said foam-forming composition comprising:
an aqueous emulsion or solution of a natural or synthetic film-forming polymer;
a surfactant;
hydrogen peroxide; and
an activating agent which causes said hydrogen peroxide to release oxygen gas sufficient to produce a foam.

2. The method of claim 1, wherein said aqueous emulsion is a latex emulsion.

3. The method of claim 1, wherein said film forming polymer is selected from styrene-butadiene, carboxylated styrene-butadiene, ethylene vinyl acetate, polyvinyl acetate, vinyl acetate, polyvinyl chloride, chloroprene, neoprene, silicone rubber, natural rubber, polyvinyl alcohol, polyvinyl alcohol stabilized with bromine, acrylic, styrene acrylic, vinyl acrylic, or mixtures thereof.

4. The method of claim 1, wherein said activating agent is a protein or an oxidizing/reducing agent.

5. The method of claim 1, wherein said activating agent is an enzyme.

6. The method of claim 1, wherein said activating agent is selected from catalase, chymotrypsin, lipase, rennet, trypsin, actinidin, α-amylase, β-amylase, bromelain, β-glucanase, ficin, lipoxygenase, papain, asparaginase, glucose isomerase, penicillin amidase, protease, pullulanase, aminoacylase, glucoamylase, cellulase, dextranase, glucose oxidase, lactase, pectinase, pectin lyase, protease, raffinase, invertase, or mixtures thereof.

7. The method of claim 1, wherein said activating agent is catalase.

8. The method of claim 1, wherein said activating agent is a yeast.

9. The method of claim 1, wherein said activating agent is Saccharomyces cerevisiae.

10. The method of claim 1, wherein said activating agent is selected from CuCl₂, CuO, ZnO, MnO₂, KI, Fe(II) oxides, Fe(III) oxides, or iron oxide-bearing clay.

11. The method of claim 1, wherein said aqueous emulsion of a natural or synthetic film-forming polymer comprises about 60% to about 99% by weight of said foam-forming composition.

12. The method of claim 1, wherein said hydrogen peroxide comprises about 0.5% to about 40% by weight of said foam-forming composition.

13. The method of claim 1, wherein said activating agent comprises about 0.05% to about 5% by weight of said foam-forming composition.

14. The method of claim 1 further comprising one or more additive selected from an accelerator, a vulcanizing agent or a gelling agent.

15. The method of claim 14, wherein said additive comprises about 0.5% to about 10% by weight of said foam-forming composition.

16. The method of claim 1, wherein said foam-forming composition further comprises an effective amount of starch.

17. The method of claim 16, wherein said starch comprises about 0.20% to about 3% by weight of said foam-forming composition.

18. The method of claim 1, wherein said foam-forming composition further comprises stearic acid or salts thereof.

19. The method of claim 18, wherein said stearic acid or salts thereof comprise about 0.10% to about 3% by weight of said foam-forming composition.

20. The method of claim 1, wherein said foam-forming composition further comprises an inorganic filler.

21. The method of claim 20, wherein said inorganic filler comprises up to about 45% by weight of said foam-forming composition.

22. The method of claim 2, wherein said latex emulsion is a blend of natural rubber latex and synthetic rubber latex.

23. The method of claim 2, wherein said latex emulsion is 100% synthetic rubber latex.

24. The method of claim 1, wherein said foam-forming composition further comprises a time-based gelling agent.

25. The method of claim 1, wherein said foam-forming composition further comprises an antimicrobial agent.

26. The method of claim 1, wherein said foam-forming composition further comprises a fire retardant.

27. The method of claim 1, wherein said foam-forming composition comprises greater than 60% by weight solids.

28. The method of claim 1, wherein said quantity of said foam-forming composition is provided by spraying.

29. The method of claim 1, wherein said surfactant comprises about 0.5% to about 20% by weight of said composition.

30. An insulated structure comprising:
a first structural component;
a second structural component; and
a foam composition at least partially disposed between said first and second structural components, said foam being formed in situ from a composition comprising:
a latex emulsion or solution of a natural or synthetic film-forming polymer;
a surfactant;
hydrogen peroxide; and
an activating agent which causes said hydrogen peroxide to release oxygen gas sufficient to produce said foam.

31. The insulated structure of claim 30, wherein said first and second structural components form at least a portion of a wall of a building.

32. The insulated structure of claim 30, wherein said first and second structural components form at least a portion of a floor of a building.

33. The insulated structure of claim 30, wherein said first and second structural components form at least a portion of a ceiling of a building.

34. The insulated structure of claim 30, wherein said first and second structural components form at least a portion of a roof of a building.

35. The insulated structure of claim 30, wherein said first and second structural components are selected from adjacent wall studs, adjacent floor joists, adjacent ceiling joists and adjacent roof rafters.

36. An insulated structure comprising:
a first structural component;
a second structural component; and
a foam composition at least partially disposed between said first and second structural components, said foam composition comprising:
a latex emulsion or solution of a natural or synthetic film-forming polymer; and
a surfactant; and
wherein said foam composition is free of hazardous volatile organic compounds.

37. A method comprising:
producing a foam by mechanically frothing a composition comprising:
a latex emulsion or solution of a natural or synthetic film-forming polymer; and
a surfactant, wherein said foam is free of hazardous volatile organic compounds; and
disposing said frothed foam on structural element to be insulated.

38. A method comprising:
providing a quantity of a foam-forming composition on a substrate to be insulated; and
permitting said foam-forming composition to expand to form a foam, said foam-forming composition comprising:
an aqueous emulsion or solution of a natural or synthetic film-forming polymer;
a surfactant;
hydrogen peroxide; and
an activating agent which causes said hydrogen peroxide to release oxygen gas sufficient to produce a foam.

39. A method comprising:
combining an aqueous emulsion or solution of a natural or synthetic film-forming polymer, a surfactant, hydrogen peroxide and an activating agent to form a foam-forming composition;
applying said foam-forming composition to a substrate;
permitting said foam-forming composition to produce a foam by the decomposition of said hydrogen peroxide; and
permitting said foam-forming composition to dry and cure.

40. The method of claim 38, wherein said foam-forming composition is applied to said substrate by spraying.

41. An insulating foam composition comprising:
a latex emulsion or solution of a natural or synthetic film-forming polymer;
a surfactant;
hydrogen peroxide; and
an activating agent which causes said hydrogen peroxide to release oxygen gas sufficient to produce said foam.

42. The insulating foam composition of claim 41, wherein said composition comprises:
about 15% to about 99% by weight latex emulsion or solution of a natural or synthetic film-forming polymer;
about 0.5% to about 20% by weight surfactant;
about 0.5% to about 40% by weight hydrogen peroxide; and
about 0.05% to about 5% by weight activating agent.

43. A method comprising providing a quantity of a foam composition between structural elements, said foam composition comprising:
an aqueous emulsion or solution of a natural or synthetic film-forming polymer; and
a surfactant;
said foam composition being formed by mechanical frothing and being substantially free of undesirable VOCs.
